(19) United States
(12) Patent Application Publication
(10) Pub. No.: US 2003/0116680 A1
(43) Pub. Date: Jun. 26, 2003

(54) Payload transfer and release system

(76) Inventor: Jung-Yuan Wang, Mississauga (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/023,981

(22) Filed: Dec. 21, 2001

(51) Int. Cl. F41J 9/08; A63H 27/08; B64C 31/06; A01K 89/02

(52) U.S. Cl. 244/155 R

(57) ABSTRACT

In one aspect, the invention relates to a payload transfer and release system for a kite including a potential energy storage unit for releasably storing potential energy, a launcher, a receptacle, an optional payload and an optional stopper. The potentially energy storage unit is, in one embodiment, an elastic band. The launcher includes a body which has a hook to which the launcher mounts. The receptacle is for holding a payload and has an outlet for releasing the payload. The receptacle has at least one mounting connector for slidably connecting the receptacle to a kite string, and a receiving portion for releasably receiving a portion of the elastic band. In use, the receptacle holding the payload can be launched to travel on the kite string. The receptacle can be stopped by the stopper, at which point, the payload leaves the receptacle.

### FIELD OF THE INVENTION

The present invention relates to kites, and more particularly the invention relates to a system for transferring and releasing a payload from a height on a kite string attached to a kite in flight.

### BACKGROUND OF THE INVENTION

During the flying of a kite, the enjoyment to the user can be enhanced by having a payload drop from a height from the kite while in flight. Several devices have been developed for this purpose. One such device holds a payload in a pair of jaws underneath the kite. The jaws are held shut by a piece that chemically degrades over time. Once sufficiently degraded, the jaws then open, releasing the payload.

Another device includes a pouch having a pocket formed by two adjacent panels of kite material, underneath the body of the kite. The pocket has a mouth that is kept closed by the tension in the kite string. The mouth is opened by releasing the tension in the kite string. A payload is thus released from the pocket.

Another device is a glider that ‘climbs’ the kite string of a kite in flight, by means of a wind force. After climbing the kite string, the glider then descends back along the kite string to the user.

There exists a continuing need for ways to enhance the enjoyment of flying a kite, and in particular for ways to transfer a payload to a height on a kite during flight and to release the payload from a height.

### SUMMARY OF THE INVENTION

In one aspect, the invention is directed to a transfer and release system for a payload, for use with a kite having a kite string. The transfer and release system comprises a potential energy storage unit, a launcher and a receptacle. The potential energy storage unit is for storing potential energy and for converting potential energy into kinetic energy. The launcher has a body and a mount on the body for receiving the potential energy storage unit. The receptacle is for holding a payload. The receptacle has an outlet for releasing the payload. The receptacle has at least one connector for slidably connecting the receptacle to the kite string, and a receiving portion for releasably receiving a portion of the potential energy storage unit.

### BRIEF DESCRIPTION OF THE DRAWINGS

The present invention will now be described by way of example only with reference to the attached drawings in which:

FIG. 1 is a side view of a payload transfer and release system in accordance with a first embodiment of the invention;

FIG. 2 is a side view of a launcher and energy storage unit shown in FIG. 1;

FIG. 3 is a perspective view of a receptacle shown in FIG. 1, with a portion cut away; and

FIG. 4 is a side view of the payload transfer and release system of FIG. 1 in operation.

### DETAILED DESCRIPTION OF THE DRAWINGS

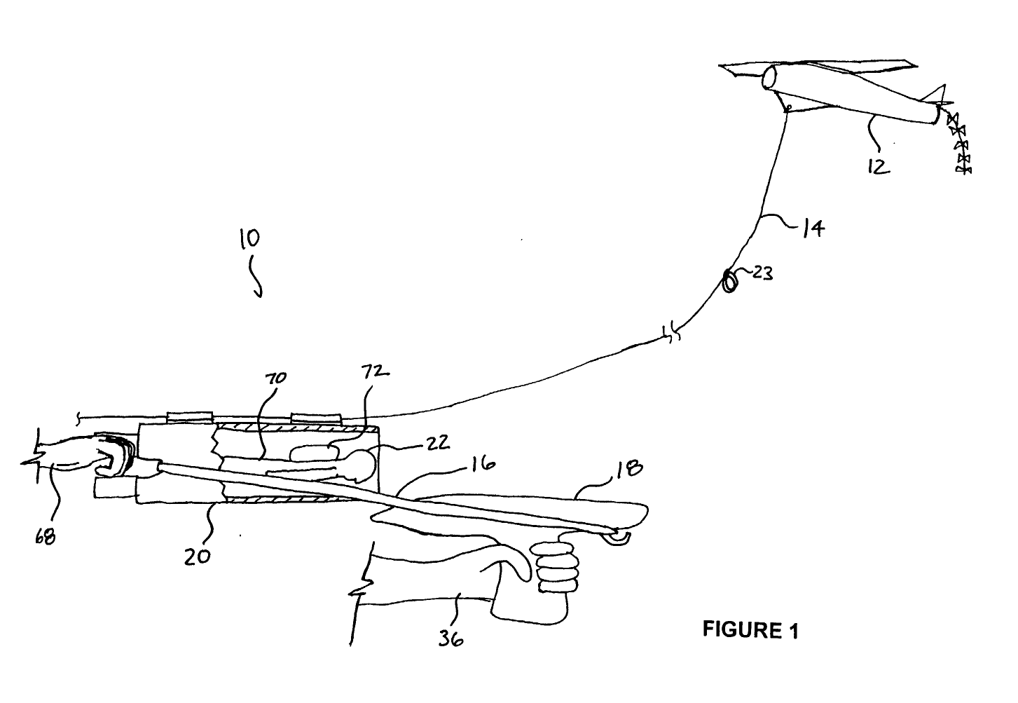

Reference is made to FIG. 1 which illustrates a payload transfer and release system 10 made in accordance with a first embodiment of the present invention and which will be used for the purposes of describing the operational aspects of the invention.

The payload transfer and release system 10 may be used in conjunction with a kite 12. Kite 12 can be any device which is airborne and which is connected to a user by a line or string 14. System 10 includes an energy storage unit 16, a launcher 18, a receptacle 20, an optional payload 22, and an optional stopper 23. The payload transfer and release system 10 can be used to launch payload along the kite string 14 and to eject the payload into the air.

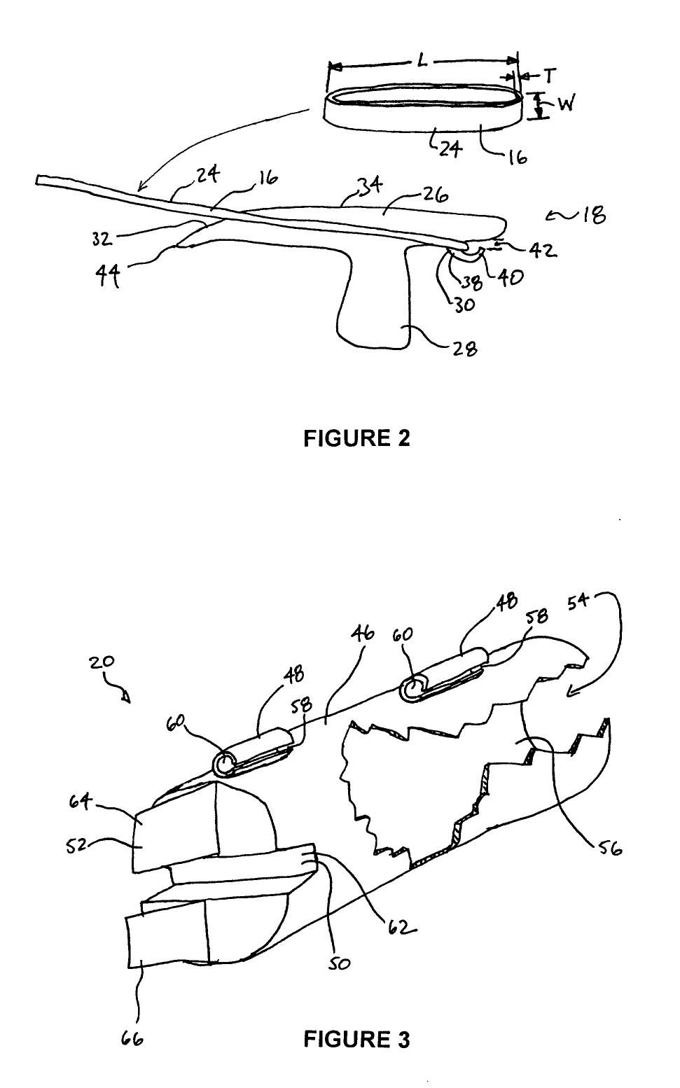

Reference is made to FIG. 2, which shows the energy storage unit 16 and the launcher 18. The energy storage unit 16 may be any device that stores potential energy and converts the potential energy into kinetic energy. The energy storage unit 16 may be, for example, a closed loop band 24 of elastic material. The band 24 acts as a tension spring, and stores mechanical potential energy when stretched. At rest, the band 24 has a length L, a width W, and a thickness T. The band 24 may be configured to have any suitable length L, width W and thickness T for the storage of sufficient potential energy for the launching of the receptacle 20 and the payload 22. For the purposes of this embodiment, width W is larger than thickness T.

The launcher 18 is used for launching the receptacle 20 and the payload 22 up the kite string 14. The launcher 18 includes a body 26, a handle 28, a mount 30 for the energy storage unit 16 and a protector portion 32. The body 26 includes a top surface 34, which is smooth, permitting the receptacle 20 to slide over it during launching. The handle 28 is for gripping in a user's hand 36, (see FIG. 1), during the launching of the receptacle 20 and payload 22. The mount 30 may have any other suitable configuration for receiving the energy storage unit 16. Preferably, the mount 30 can releasably receive the energy storage unit 16, so that unit 16 may be replaced when desired. For example, the mount 30 may be a hook 38 that is positioned underneath the body 26, forward of the handle 28. The hook 38 has a bight 40 that preferably faces forward. A gap 42 is formed between the tip of the bight 40 and the body 26. The hook 38 is configured so that the gap 42 is roughly the size of the thickness T of the band 24, so that it is large enough to permit the band 24 to slide onto the hook 38 thicknesswise, but not widthwise. This inhibits the accidental loss of the band 24 from the hook 38, particularly during launching. The hook 38 is configured with the gap 42 so that the band 24 may be replaced with a new band, or a band having different elastic properties. Alternatively, for example, the mount 30 may be a simple post attached to the launcher 18.

The protector portion 32 extends behind the handle 28 on the body 26, and protects the user's hand 36 from contact by the receptacle 20 and the band 24 during launching. The top surface of the protector portion 32 is sloped downwards rearwardly, reducing the risk of contact between the receptacle 20 and the rearmost edge 44 during launching. The top surface of the protector portion 32 smoothly joins with the top surface of the body 26, so that the travel of the receptacle 20 is not impeded during launching.

Reference is made to FIG. 3, which shows the receptacle 20. The receptacle 20 holds the payload 22 (see FIG. 1), and releases the payload 22 at a point at or near the top of the travel of the receptacle 20 on the kite string 14. The receptacle 20 includes a body 46, two mounting connectors 48, a receiving portion 50 and a handle 52. The body 46 holds the payload 22 and has an outlet 54 through which the payload 22 is released. Preferably, as shown, the outlet 54 is open, so that there is no obstruction to the release of the payload 22. The outlet 54 may alternatively have a hinged lid (not shown), which is opened when the payload 22 is ejected, either by the momentum in the payload 22 or by some other suitable mechanism. The outlet 54 is preferably at the end of the body 46, so that the payload 22 can be easily released from the outlet 54. Alternatively, however, the outlet 54 may be positioned on another portion of the body 46. For example, the outlet 54 may be positioned midway along the bottom of the receptacle, so that the payload 22 can drop out of the outlet 54.

The body 46 may be any shape suitable for the transfer and release of the payload 22. For example, as shown body 46 may be cylindrical so that there is reduced friction and a reduced opportunity for the payload 22 to get stuck during the payload release. Preferably body 46 has a smooth interior wall 56 for reduced resistance to the release of the payload 22.

The mounting connectors 48 are positioned on the upper portion of the receptacle 20 and enable the receptacle 20 to be held slidably on the kite string 14. The connectors 48 are cylindrical tubes and have a longitudinal slot 58 across their entire length near the bottom permitting the connectors 48 to be hooked directly to the kite string 14 at any point along the kite string 14, without having to thread an end of the kite string 14 through them. The connectors 48 have smooth, low friction interior surfaces 60 for reduced resistance as the receptacle 20 travels up the kite string 14. To further reduce friction the connectors 48 are relatively short. The connectors 48 are made from a durable heat resistant material, such as brass or aluminum or some other metal that can withstand the heat buildup during use and the wear from repeated use.

A single connector could alternatively be used instead of the two connectors 48, however the single connector would have to be long enough to ensure that the receptacle 20 is supported suitably to prevent the inadvertent premature release of the payload 22 while traveling on the kite string 14. Thus, a single connector would extend along a substantial portion of the length of the receptacle body 46.

The receiving portion 50 is for releasably receiving a portion of the energy storage unit 16. For receiving a portion of the band 24, for example, the receiving portion 50 may be a slot 62 across the rear of the body 46. The slot 62 is preferably large enough so that the band 24 is easily released from the slot 62 after launching of the receptacle 20. The slot 62 extends across the entire rear surface of the body 46 to ensure that the band does not slip out prematurely during launching of the receptacle 20.

The receptacle handle 52 preferably extends rearwardly from the body 46 for gripping by the user during launching. The receptacle handle 52 may have any suitable shape for gripping by the user. For example, the receptacle handle 52 may include an upper fin 64 and a lower fin 66, which are grippable in the user's other hand 68 (see FIG. 1).

The payload 22 includes a body 70 and a parachute 72. The body 70 is preferably in the general shape of a human. Alternatively however, the body 70 can be of any suitable shape for easy release from the receptacle 20. The parachute 72 is attached to the body 70 and is configured to deploy and reduce the speed of descent of the body 70 after the body 70 has been released from the receptacle 20 in the air.

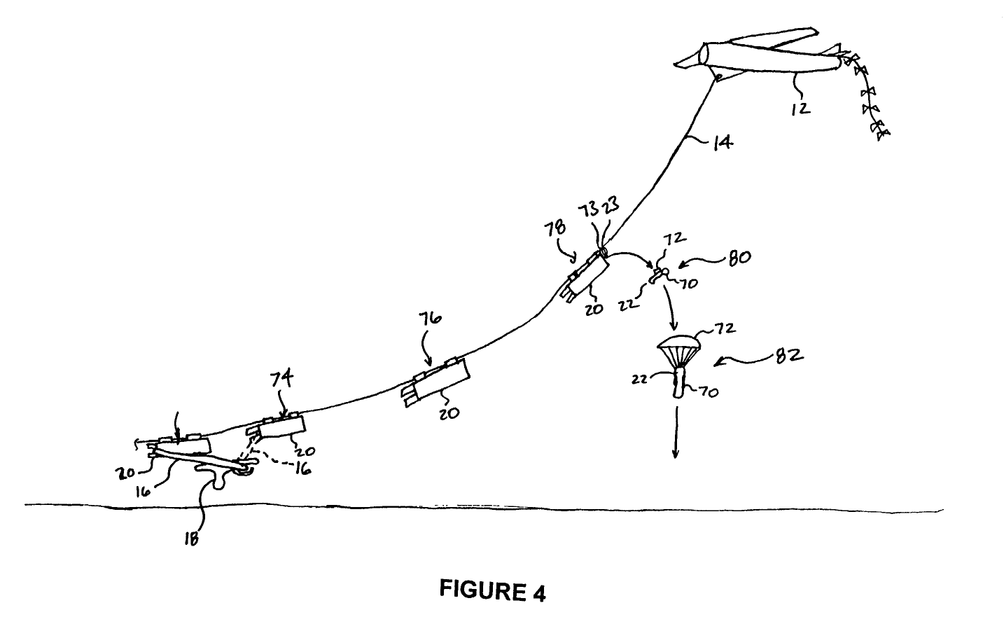

Reference is now made to FIG. 4. The stopper 23 can be fixedly mounted at some intermediate point on the kite string 14 to stop the travel of the receptacle 20 up the kite string 14, thereby initiating the release of the payload 22 from the receptacle 20. Preferably, the stopper 23 is removably, fixedly attachable to the kite string 14. The stopper 23 may have any suitable shape to stop the travel of the receptacle 20. For example, as shown, the stopper 23 may be an annular ring 73, which can be tied to the kite string. Alternatively, the stopper 23 may be an alligator clip or some other clamping device which can be clipped onto the kite string. Alternatively, however, the stopper 23 may be permanently, fixedly attachable to the kite string 14. For example, the stopper 23 may be glued onto the kite string 14, or may comprise a permanently knotted portion of the kite string 14.

In operation, the payload transfer and release system 10 is first arranged as shown in FIG. 1. The optional stopper 23 may be mounted to the kite string 14. The stopper 23 should be mounted at a point on the kite string 14 where the receptacle can reach during its travel. The payload 22 is inserted into the receptacle 20. The receptacle is hooked onto the kite string 14 of the kite 12 in flight. The band 24 is connected to the hook 38 on the launcher 18. A portion of the band 24 is inserted into the slot 62 on the receptacle 20. The receptacle 20 is drawn rearwardly using the receptacle handle 52, so that the band 24 is stretched, thus storing potential energy in the band 24. The handle 52 of the receptacle 20 is then released, so that the receptacle 20 is then launched forwardly on the kite string 14 by the tension in the band 24.

Reference is now made to FIG. 4, which shows the travel path of the receptacle 20 and payload 22. The receptacle 20 accelerates until the potential energy in the band 24 is substantially or completely released, some is converted into kinetic energy in the receptacle 20. The band 24 is released from the slot 62 as the receptacle 20 travels past the launcher 18 on the kite string 14, as shown at 74. The receptacle 20 travels up the kite string 14, as shown at 76. The receptacle 20 contacts the stopper 23 and stops, as shown at 78. The payload 22, which still has momentum, continues to travel and thus leaves the receptacle 20, as shown at 80. The parachute 72 on the payload 22 deploys as a result of the air resistance as the payload 22 moves through the air, as shown at 82. The payload 22 then descends to the ground with the parachute 72.

During the flight of the kite 12, depending on the wind conditions and the total surface area of the kite 12, the kite string 14 is usually somewhat curved, as shown in FIG. 4. In the event that the kite string 14 has a relatively sharp curve, the stopper 23 may not be required for the operation of the system 10. The portion of the kite string 14 where the curvature is most pronounced may decelerate the receptacle rapidly enough that the payload 22 may be released, without the use of the stopper 23.

The payload transfer and release system 10 has been shown to include a payload 22. Alternatively, the system 10 can be made without a payload 22, so that the user can supply his or her own desired payload. Furthermore, the payload can alternatively have no parachute, and can simply free fall to the ground. As a further alternative, the payload can have some other suitable wind catching element for slowing its descent.

The energy storage unit 16 has been shown to be a single closed loop band 24 of elastic material. The energy storage unit 16 can alternatively be an open band having two ends. In this alternative case, the mount 30 on the launcher may require configuring to receive the open band. For example, the mount 30 on the launcher may comprise two posts, to which the ends of the open band can be tied.

As another alternative, the energy storage unit 16 can be a coil spring, or a leaf spring, or any other suitable potential energy storage means. In this alternative case, the mount on the launcher and the receiving portion on the receptacle will require configuring to receive the energy storage unit. For example, in the case where the energy storage unit 16 is a compression coil spring, then the mount 30 on the launcher may be a cylindrical depression in the front end of the launcher, and the receiving portion 50 on the receptacle may be a similar cylindrical depression on the rear end of the receptacle.

It has been disclosed for the band 24 to have a width W that is larger than the thickness T. Alternatively, the width W and the thickness T may be selected to have any desired or suitable relationship. The gap 42 between the bight 40 of the hook 38 and the body 26 of the launcher 18 is preferably selected so that the band 24 does not easily release from the launcher 18, thereby reducing the likelihood of inadvertently losing the band 24.

The bight 40 of the hook 38 has been shown to be forward facing. However, the hook can alternatively have a rearwardly facing bight or alternatively any other suitable configuration for releasably holding the energy storage unit 16.

The body of the receptacle 20 has been shown to be cylindrical. Alternatively the body can have any suitable shape permitting the easy release of a held payload. For example, the body can have a square or rectangular shape or a cone shape wherein the base of the cone is the open end.

As will be apparent to persons skilled in the art, various modifications and adaptations of the apparatus described above without departure from the present invention, the scope of which is defined in the appended claims.

1. A transfer and release system for a payload, for use with a kite having a kite string, comprising:
a) a potential energy storage unit for storing potential energy and for converting potential energy into kinetic energy;
b) a launcher having a body and a mount on said body for receiving said potential energy storage unit; and
c) a receptacle for holding a payload, said receptacle having an outlet for releasing the payload, said receptacle having at least one connector for slidably connecting said receptacle to the kite string, and a receiving portion for releasably receiving a portion of said potential energy storage unit.

2. A payload transfer and release system as claimed in claim 1, wherein said potential energy storage unit is a band of elastic material.

3. A payload transfer and release system as claimed in claim 2, wherein said band of elastic material is a closed loop band, and said mount on said launcher comprises a hook having a bight, such that a gap exists between said bight and said body of said launcher, for releasably holding said band of elastic material.

4. A payload transfer and release system as claimed in claim 1, wherein said launcher includes a handle for gripping by the hand of a user.

5. A payload transfer and release system as claimed in claim 4, wherein said launcher further includes a protector portion attached to said body, so that in use, said protector portion is positioned between said receptacle and the hand of a user.

6. A payload transfer and release system as claimed in claim 1, wherein said at least one connector on said receptacle includes a cylindrical tube having a longitudinal slot extending across the entire length of said tube so that said tube and said attached receptacle can hook directly to any point on the kite string and hang therefrom.

7. A payload transfer and release system as claimed in claim 1, wherein said receptacle has an interior surface and said interior surface is cylindrical.

8. A payload transfer and release system as claimed in claim 1, further comprising a payload including a payload body and a parachute attached to said payload body.

9. A payload transfer and release system as claimed in claim 8, wherein said payload body is shaped in the general form of a human.

10. A payload transfer and release system as claimed in claim 1, further comprising a stopper, said stopper being fixedly attachable to the kite string for stopping said receptacle in motion up the kite string.

11. A payload transfer and release system as claimed in claim 1, wherein said stopper is removably, fixedly attachable to the kite string.

12. In combination, a kite having a kite string and the payload transfer and release system of claim 1.

13. A transfer and release system for a payload, for use with a kite having a kite string, comprising:
a) a potential energy storage means for storing potential energy and for converting potential energy into kinetic energy;
b) a launching means having a body and mounting means on said body for receiving said potential energy storage means; and
c) a receptacle means for holding a payload, said receptacle means having an outlet for releasing the payload, said receptacle means having at least one connector means for slidably connecting said receptacle means to the kite string, and a receiving means for releasably receiving a portion of said potential energy storage unit.

14. A transfer and release system for a payload, for use with a kite having a kite string, comprising:
a) a potential energy storage unit for storing potential energy and for converting potential energy into kinetic energy;
b) a launcher having a body and mounting means on said body for receiving said potential energy storage unit and
c) a receptacle for holding a payload, said receptacle having an outlet for releasing the payload, said receptacle having at least one connector means for slidably connecting said receptacle to the kite string, and a receiving means for releasably receiving a portion of said potential energy storage unit.
